(19) United States
(12) Patent Application Publication
(10) Pub. No.: US 2019/0196883 A1
(43) Pub. Date: Jun. 27, 2019

(54) "See You There" Smartphone Application

(71) Applicant: Christian Reyes, Denver, CO (US)

(72) Inventor: Christian Reyes, Denver, CO (US)

(21) Appl. No.: 16/046,067

(22) Filed: Jul. 26, 2018

Related U.S. Application Data
(60) Provisional application No. 62/537,194, filed on Jul. 26, 2017.

(51) Int. Cl. G06F 9/54; G06Q 50/00; G06Q 10/02; G06Q 10/10; G06F 3/0482

(52) U.S. Cl. CPC G06F 9/542; G06Q 50/01; G06F 3/0482; G06Q 10/1095; G06Q 10/02

(57) ABSTRACT

See You There app, designed to inform users about events, such as parties, concerts, and entertainment at local clubs, as well as commerciai and institutional entities seeking to advertise sales, promotions, and fundraisers, quickly and easily, and also providing the when-and-where of the event, and any policy regarding admission.

### CLAIM OF PRIORITY

This patent application claims priority under 35 USC 119 (e) (1) from U.S. Provisional Patent Application Ser. No. 62/537,194 filed Jul. 26, 2017, of common inventorship and title herewith, which is incorporated herein by reference as though the same were set forth in its entirety.

### FIELD OF THE INVENTION

The present invention pertains to the field of smartphone ations, and more specifically to the field of smartphone applications for informing users about events quickly and easily, and also providing the when-and-where of the event, and any policy regarding admission.

### BACKGROUND OF THE INVENTION

In an electronicaly interconnected age, a time in which almost everyone carries smartphones and have the world at their fingertips, there remains the age-old problem of what to do with an empty Saturday night or Sunday afternoon. At such times, although one knows that there are things going on, such as events, parties, sales, promotions, the problem is that unless a person knows the particulars of time, place, and admittance, they still find themselves with time on their hands and nothing to do with it. What is needed, then, is some means of quickly and easily getting and sharing the relevant information about our options for the afternoon or evening, or the week or weekend ahead. And what the host throwing a party (or the business or institution hosting an event or conducting a promotion) needs, likewise, is some effective means of publicizing the particulars of their party or event.

The prior art has put forth several designs for smartphone applications. Among these are:

US Patent Application No. 2014/0379390 to David Scarborough provides location-based information used to estimate which tickets are likely to be unused and to provide channels through which such tickets can be reassigned to others capable of attending the appropriate event. Locations of users (e.g., ticket holders or users interested in an event) are tracked (e.g., by tracking a user device or determining whether the user has redeemed other related tickets, such as a parking voucher), and it is estimated whether and/or when the user could arrive at the event. If it is unlikely that a ticket holder will be able to arrive at the event, an electronic offer can be presented to the ticket holder to surrender the ticket (which may result in a partial or full compensaton). If the ticket is surrendered, the ticket can be electronically offered to another user selected based on the user's location and/or relationship to the initial ticket provider.

U.S. Pat. No. 9,117,220 to Gregory P. Whalin provides a computer-implemented method to help organize in-person gatherings of users of topic-related interest includes the steps of providing a web-based meeting facility to a plurality of users with each of the plurality of users choose to join meeting groups based on topic-related interest and geographic locale, enabling an organizer to maintain control of organizing meetings with the meeting groups with the meeting groups made up of a subset of the plurality of users, and providing the organizer with a revenue generation facility where the organizer generates revenue through commercial sponsorship of at least one of the meeting group and specific meetings.

US Patent Application No. 2014/0257885 to Ashley Gibson provides a system and methods for providing location-based upcoming event information using a client-side web application implemented on a client device are described. The location-based upcoming event information may be provided to users of an online secondary ticket marketplace using a client-side web application implemented as desktop or mobile widget or within a web browser toolbar. The client-side web application may be configured to communicate with a network-based system that provides online marketplace and ticket fulfillment services and generate a query based upon the location of a user and other event criteria. The client-side web application may communicate the query to the network-based system and, in response, receive location based upcoming event information which may be displayed to a user as a list and/or information on a map. The client-side web application may display an aggregate of ticket inventory available from multiple online marketplaces providing the user with multiple purchasing options.

None of these prior art references describe the present invention.

### SUMMARY OF THE INVENTION

It is an object of the present invention to provide a See You There smartphone software application for informing users about events quickly and easily, and also providing the when-and-where of the event, and any policy regarding admission.

### BRIEF DESCRIPTION OF THE DRAWINGS

FIG. 1 is a perspective view illustrating a tablet of the See You There smartphone application, constructed in accordance with the present invention.

FIG. 2 is a perspective view illustrating a cell phone of the See You There smartphone application, constructed in accordance with the present invention.

FIG. 3 is a screen shot of the See You There smartphone application, constructed in accordance with the present invention.

FIG. 4 is a series of screen shots of the See You There smartphone application, constructed in accordance with the present invention.

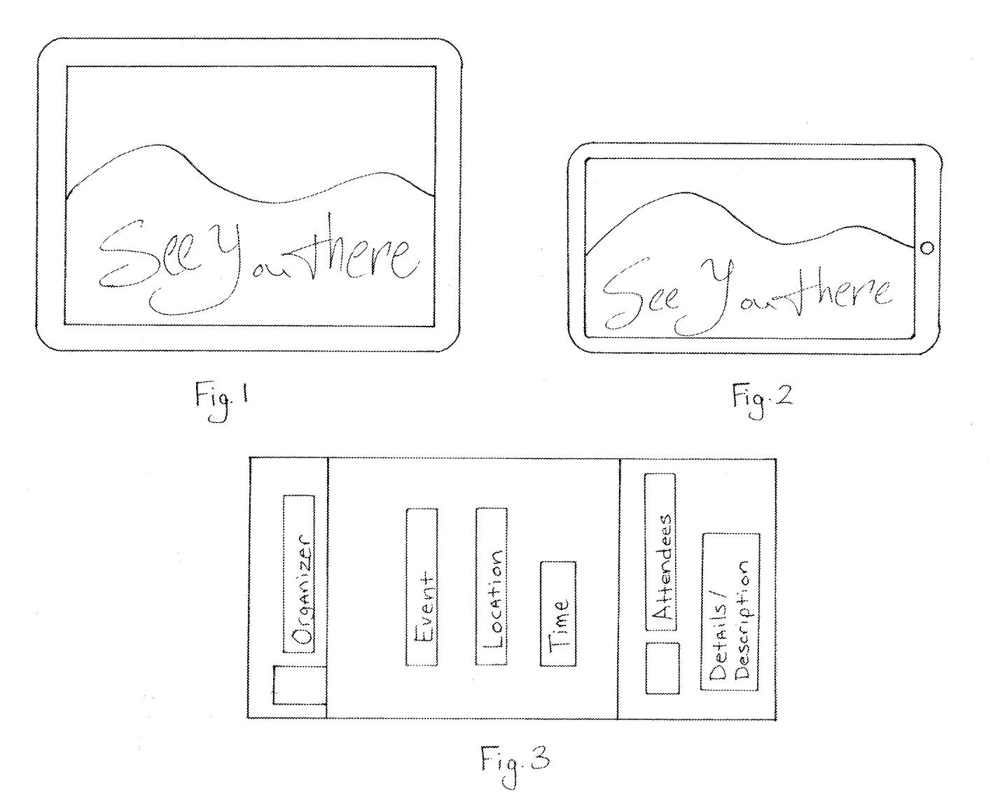

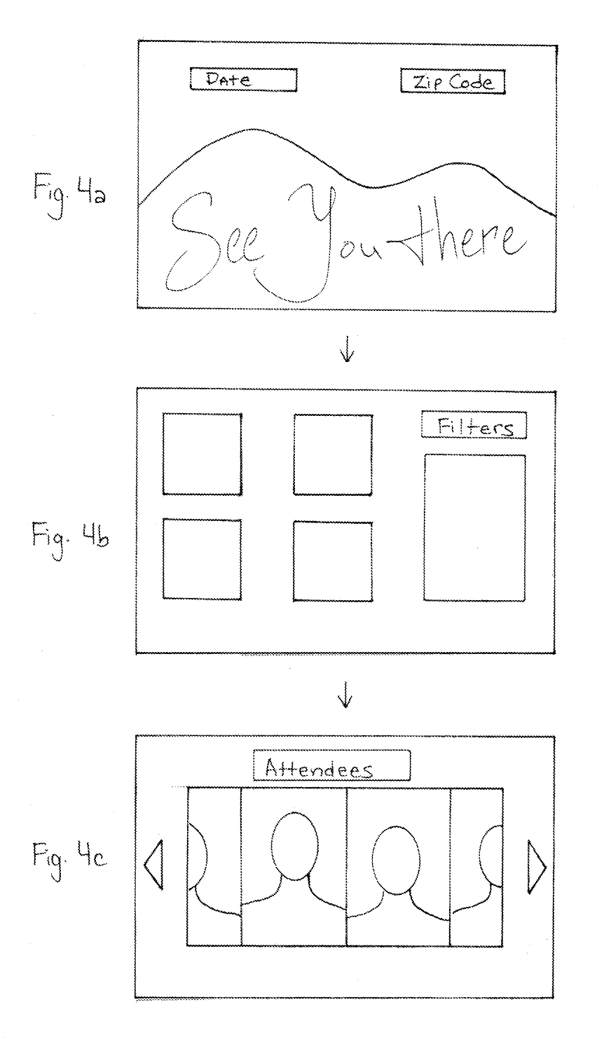

### DETAILED DESCRIPTION OF THE INVENTION

The present invention a Smartphone Application, aptly entitled the See You There app, designed to inform users about events, such as parties, concerts, and entertainment at local clubs, as well as commercial and institutional entities seeking to advertise sales, promotions and fundraisers, quickly and easily, and also providing the when-and-where of the event, and any policy regarding admission. With the See You There app, then, users have an immediate, detailed list of possible places to go and things to do in their leisure time; and an immediate way of sharing this information with their friends. Business and institutional concerns, too, will have an immediate means of publicizing their events.

The See You There app is downloaded to a smartphone for either a small one-time charge (per download), or offered for free and paid for by advertisers, i.e., the commercial or institutional establishments using the app to publicize their events and promotions. Once installed, the See You There app will, at the press of an on-screen icon, display all the events, parties, concerts, sales, and promotional events scheduled for a given day, week, or weekend, specific to the user's immediate locale. In the San Francisco Bay area, for example, offerings include not only parties, what bands are playing where, and so forth, but also region-specific events such as wine-tastings in the Napa Valley. On the coast of Maine, on the other hand, the See You There app might include maritime events such as a fleet of schooners sailing into Camden Harbor, lighthouse tours, or blueberry-picking on neighborhood farms. The See You There app, then, operates in a manner specific to the user's locale, giving users the what, where, and when of leisure-time opportunities in their own city, region, or metropolitan area.

Among the functions and capabilities of the See You There app, the See You There app informs users about the widest variety of entertainment and leisure options, from the smallest house-party to the biggest concert. Through filtering, the See You There app enables users to match his or her own preferences to the opportunities displayed. Thus, the user might employ the “music filter” to find nightclub jazz, EDM, or heavy-metal concerts, and to filter out the genres in which they have no interest. The See You There also enables users to “pre-select” certain events, parties, and so on, and to chat with others who have pre-selected them. This allows users to get to know one another, virtually, through the app, prior to actually meeting at the event. Because the See You There app posts the details of events weeks prior to their occurrence, users can use the app to plan their evening's or weekend's entertainment far in advance.

The See You There app enables users already at an event or concert to communicate with other users. Users at the event, for example, could text everyone on the See You There “watch list” to let them know how the event is going, and even provide other See You There app users with live video feeds from the event. This feature enables users to “sample” a party or event prior to actually attending it, so that the user can skip a concert that was going poorly, or avoid parties with people they'd rather not see. Also, by “sampling” the event beforehand, the user saves an otherwise wasted night, do something else listed on the See You There app, and save on gas.

Because each See You There app user creates his or her own profile for the app, the See You There app can lead to friendships among users who have similar interests. Wildlife enthusiasts on the coast of South Carolina, for example, can use the See You There app to spread the word on saving sea-turtle nesting sites; and users can get to know one another well before the day they all gather to work on the beach.

Another great feature of the See You There apps is its emphasis on local events and leisure possibilities. The business traveler or vacationer, for example, can travel from Cleveland to Southern California, and immediately see what leisure opportunities Southern California affords. This region-specific quality of the See You There app makes it ideal for anyone who travels for work or pleasure.

The See You There app, then, offers users a quick, simple, and sophisticated means of checking out local events, parties, promotions, vand other opportunities for leisure activity, wherever the user may be. But the benefits of the See You There app are not restricted to the consumers who would use the app because the persons, commercial and business establishments, and institutional entities seeking to publicize their events would benefit too, by reaching the very people they hope will attend their party, concert, sale, promotion, or event. Further, the entities using the See You There app who publicize their offerings r might well pay for the privilege, thus creating a dependable revenue-stream and enabling offers consumers the See You There app at no charge. The See You There app thus presents itself as an app that benefits both its end-users uses seeking to enjoy their leisure time), and its advertisers, the people, firms, and institutional entities (schools, churches. health-care facilities) who want their events publicized. Clever in conception and thoughtful in design, the See You There app, if successfulk;veloped and marketed, and distributed via Apple's App Store and Google Play, will find a wide and enthusiastic reception among smartphone users. not only in the United States but around the world.

Although this invention has been described with resect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A See You There smartphone application for informing users about events quickly and easily, and also providing the when-and-where of the event, and any policy regarding admission. .Anyand all invention illustrated and described herein.
